(19) United States
(12) Patent Application Publication
(10) Pub. No.: US 2017/0371655 A1
(43) Pub. Date: Dec. 28, 2017

(54) PROCESSOR AND CONTROL METHOD OF PROCESSOR

(71) Applicant: FUJITSU LIMITED, Kawasaki-shi (JP)

(72) Inventors: Masato Nakagawa, Yokohama (JP); Takumi Maruyama, Yokohama (JP); Shuji Yamamura, Yokohama (JP); Masahiro Kuramoto, Kawasaki (JP)

(73) Assignee: FUJITSU LIMITED, Kawasaki-shi (JP)

(21) Appl. No.: 15/606,097

(22) Filed: May 26, 2017

(30) Foreign Application Priority Data
Jun. 24, 2016 (JP) 2016-125576

(51) Int. Cl. G06F 9/30

(52) U.S. Cl. CPC G06F 9/3016; G06F 9/30014

(57) ABSTRACT

A processor includes: a storage unit that stores instructions; a counting unit that specifies an instruction to be decoded by a count value; a decoding unit that decodes an instruction; and a control unit that, when the decoded instruction is a repeat instruction, updates the count value of the counting unit so as to cause repeat target instructions in number corresponding to a designated number of instructions, out of instructions succeeding the repeat instruction, to be repeatedly executed a designated number of repetition times, and generates updated operands being operation objects of the repeat target instructions that are to be executed for the second or later time, and when the repeat target instructions are to be executed for the second or later time, updates operands of the repeat target instructions for use in the second or later time execution, to the generated updated operands and outputs the updated operands.

### CROSS-REFERENCE TO RELATED APPLICATION

This application is based upon and claims the benefit of priority of the prior Japanese Patent Application No. 2016-125576, filed on Jun. 24, 2016, the entire contents of which are incorporated herein by reference.

### FIELD

The embodiments discussed herein are directed to a processor and a control method of a processor.

### BACKGROUND

On a processor, repetitive arithmetic processing in which a plurality of operation instructions are repeatedly executed is implemented as illustrated in, for example, FIG. 14A. Specifically, the repetitive arithmetic processing is implemented with five phases, (1) P1401: initial setting of a data referrer which is referrer offset of operation data, (2) P1402: operation instruction, (3) P1403: update of the data referrer, (4) P1404: subtraction instruction of a repeat counter, and (5) P1405: repeat-branch instruction.

For example, if an arithmetic unit is mounted so as to perform the operation according to the flow illustrated in FIG. 14A, a phase that practically performs the operation out of the actually repeated four phases P1402 to P1405 is only (2) P1402: operation instruction. Since the processing in each phase requires one cycle or more, the minimum required number of cycles per operation instruction is four, meaning 25% execution efficiency of the operation or less, and thus the effective use of the arithmetic unit is not possible.

For example, let us consider processing where a processor including many floating-point registers repeatedly performs multiplication of the individual floating-point registers, while the register numbers are incremented by one each time, and repeats the multiplication 64 times as illustrated in FIG. 14B. As is seen in a coding example in FIG. 14C, the floating-point register numbers for use in the operation are stored in a general register and are referred to indirectly from the operation instruction, and then the operation is performed. Every time the operation instruction is executed, the values stored in the general register are updated. In this manner, the multiplication can be performed 64 times.

In FIG. 14C, an instruction “mul” corresponds to (2) P1402: operation instruction, three instructions “add” correspond to (3) P1403: update of a data referrer, an instruction “sub” corresponds to (4) P1404: a subtraction instruction of a repeat counter, and an instruction “brnza” corresponds to (5) P1405: repeat-branch instruction. In this case, the number of instructions repeated in the loop processing is six, and even if each of the instructions can be processed in one cycle, the operation instruction can be executed only once in six cycles.

To improve the operation execution efficiency of the repetitive arithmetic processing, there has been proposed a processor including a repeat instruction causing target instructions to be repeatedly executed (refer to Patent Documents 1 to 3, for instance).

Patent Document 1: Japanese Laid-open Patent Publication No. 05-120005

Patent Document 2: Japanese Laid-open Patent Publication No. 2000-187583

Patent Document 3: Japanese Laid-open Patent Publication No. 2001-175472

As a processor including a repeat instruction, there has been proposed, for example, a processor which includes a storage unit storing an output of an instruction decoding unit and in which, when an instruction turns out to be a repeat instruction as a result of the decoding of the instruction by the instruction decoding unit, the storage unit repeatedly outputs a certain number of instructions preceding the repeat instruction a designated number of times. In this processor, after the repeat instruction is given, the storage unit repeatedly outputs a sequence of instructions stored therein the designated number of times without any interval, and thus the subtraction instruction of the repeat counter and the repeat-branch instruction are eliminated as illustrated in FIG. 15A. The repetitive arithmetic processing is implemented with three phases, (1) P1501: initial setting of a data referrer, (2) P1502: operation instruction, and (3) P1503: update of the data referrer.

For example, in the execution of the processing illustrated in FIG. 14B, the instruction “sub” and the instruction “brnza” are eliminated as is seen in a coding example in FIG. 15B. The number of instructions repeated in the loop processing is four, and even if the processing of each of the instructions can be executed in one cycle, the operation instruction can be executed only once in four cycles. Thus, even the use of the repeat instruction does not sometimes improve the execution efficiency of the operation, due to the presence of wasteful instruction cycles not contributing to the operation.

### SUMMARY

According to an aspect of the embodiments, a processor includes: a storage unit that stores a plurality of instructions; a counting unit that specifies an instruction to be decoded, by a count value; a decoding unit that decodes an instruction read based on the count value from the storage unit; and a control unit that performs control relevant to the instruction. When the instruction decoded by the decoding unit is a repeat instruction, the control unit updates the count value of the counting unit so as to cause repeat target instructions in number corresponding to a designated number of instructions, out of instructions succeeding the repeat instruction, to be repeatedly executed a designated number of repetition times, and generates updated operands being operation objects of the repeat target instructions that are to be executed for the second or later time, and when the repeat target instructions are to be executed for the second or later time, updates operands of the repeat target instructions for use in the second or later-time execution, to the generated updated operands and outputs the updated operands.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processor in a first embodiment;

FIG. 2 is a diagram illustrating a configuration example of an instruction control unit in the first embodiment;

FIG. 3A and FIG. 3B are charts illustrating processing of a repeat instruction in the first embodiment;

FIG. 4A and FIG. 4B are charts illustrating implementation examples of the repeat instruction in the first embodiment;

FIG. 5 is an explanatory chart of an operand update buffer in the first embodiment;

FIG. 6 is a chart illustrating a processing example of the repeat instruction in the first embodiment;

FIG. 7 is a chart illustrating an example of how the operand update buffer is used in the processing of the repeat instruction illustrated in FIG. 6;

FIG. 8 is a diagram illustrating a configuration example of a program counter control unit in the first embodiment;

FIG. 9 is a time chart illustrating the processing example of the repeat instruction illustrated in FIG. 6;

FIG. 10 is a diagram illustrating a configuration example of a program counter control unit in a second embodiment;

FIG. 11 is a chart illustrating selection logic of a control register set in the second embodiment;

FIG. 12 is a chart illustrating a processing example of a repeat instruction in the second embodiment;

FIG. 13 is a time chart illustrating the processing example of the repeat instruction illustrated in FIG. 12;

FIG. 14A to FIG. 14C are explanatory charts of an example of conventional repetitive arithmetic processing; and

FIG. 15A and FIG. 15B are explanatory charts of another example of the conventional repetitive arithmetic processing.

### DESCRIPTION OF EMBODIMENTS

Hereinafter embodiments will be described with reference to the drawings.

### First Embodiment

A first embodiment will be described.

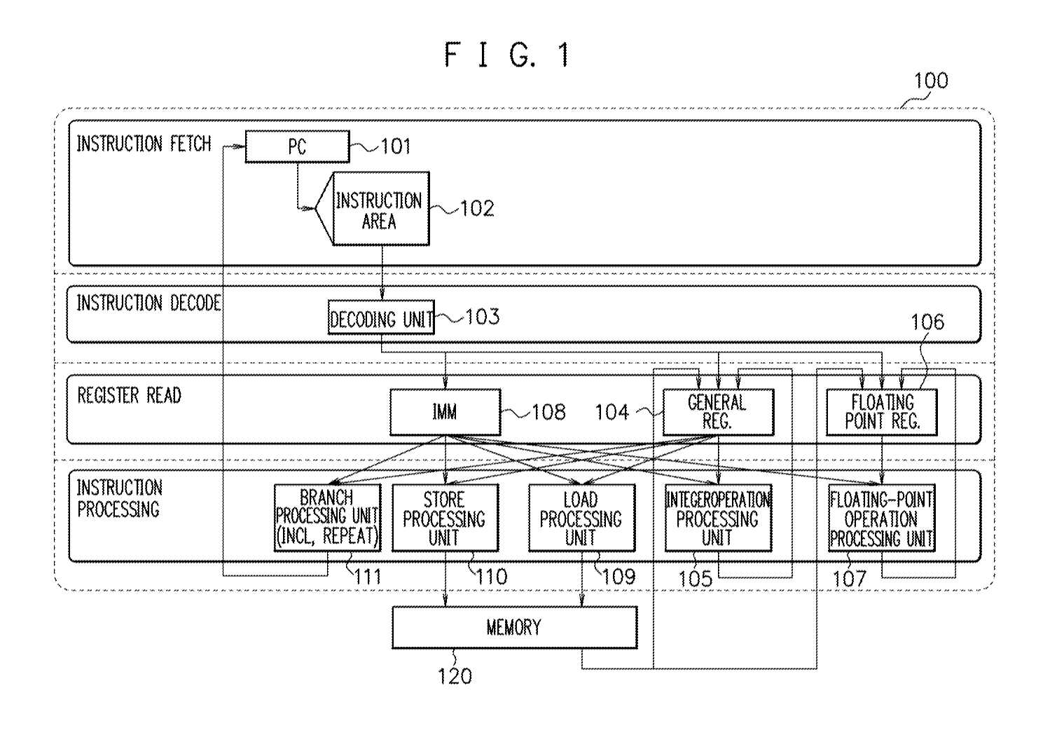

FIG. 1 is a diagram illustrating a configuration example of a processor in the first embodiment. The processor 100 in this embodiment includes a pipeline structure of an instruction fetch stage, an instruction decode stage, a register read stage, and an instruction processing stage.

In the instruction fetch stage, an instruction is read from an instruction area 102 where a sequence of instructions are stored, based on a value of a program counter (PC) 101. Instructions executable by the processor in this embodiment include a repeat instruction causing a certain number of instructions succeeding the repeat instruction to be repeatedly executed a designated number of times. In the instruction decode stage, a decoding unit 103 decodes the instruction read in the instruction fetch stage.

When the instruction turns out to be an integer operation instruction as a result of the decoding, in the register read stage, data are read from a general register 104 and an immediate data register 108, and in the instruction processing stage, an integer operation processing unit 105 executes arithmetic processing instructed by the instruction, using the read data and so on. When the instruction turns out to be a floating-point operation instruction as a result of the decoding, in the register read stage, data are read from a floating-point register 106 and the immediate data register 108, and in the instruction processing stage, a floating-point operation processing unit 107 executes arithmetic processing instructed by the instruction, using the read data and so on.

When the instruction turns out to be a load instruction or a store instruction as a result of the decoding, in the register read stage, data are read from the general register 104 and the immediate data register 108, and in the instruction processing stage, an address is created based on the read data and so on and a load processing unit 109 or a store processing unit 110 executes load processing or store processing from or to a memory 120. Data read from the memory 120 by the load processing is stored in, for example, the general register 104 or the floating point register 106. When the instruction turns out to be a branch instruction as a result of the decoding by the instruction decoding unit 230, in the register read stage, data are read from the general register 104 and the immediate data register 108, and in the instruction processing stage, a branch processing unit 111 executes branch processing based on the read data and so on and appropriately updates the value of the program counter 101 according to the processing result.

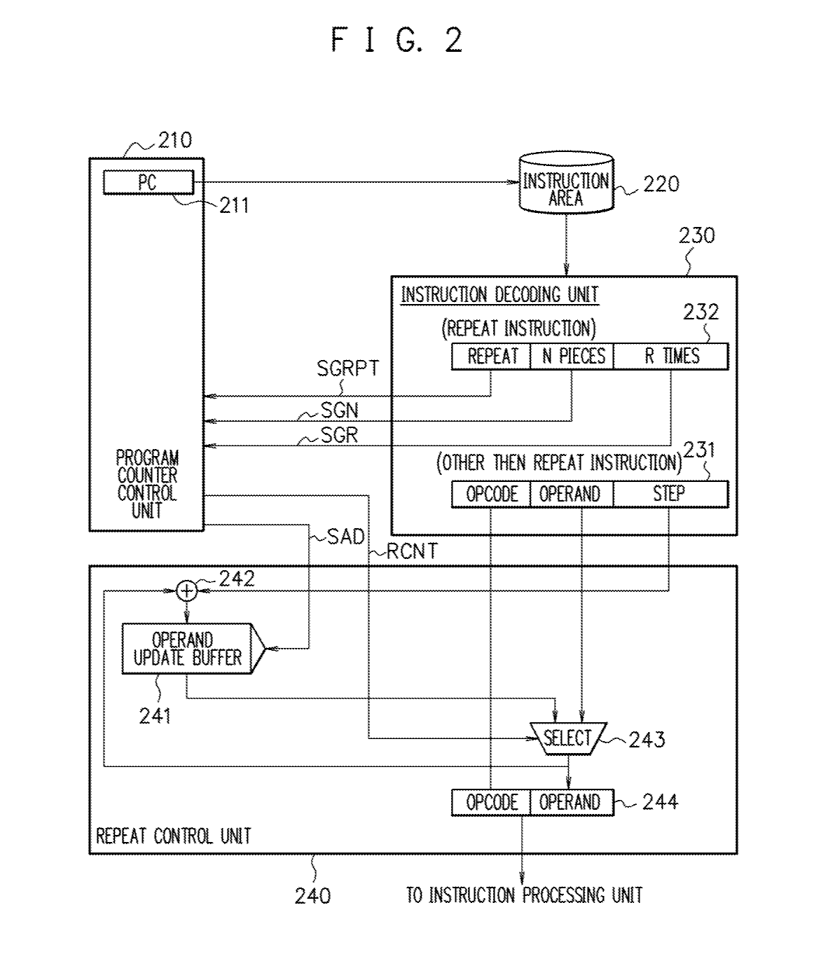

FIG. 2 is a diagram illustrating a configuration example of an instruction control unit which performs control relevant to instructions to be executed, in the processor in this embodiment. The instruction control unit in this embodiment includes a program counter control unit 210, an instruction decoding unit 230, and a repeat control unit 240.

The program counter control unit 210 performs control relevant to a program counter 211. The program counter control unit 210 normally controls a value of the program counter 211 so as to increase the value by the number of bytes of an instruction every cycle. When the instruction is a branch instruction, the program counter control unit 210 controls the value of the program counter 211 according to the processing result.

When the instruction turns out to be a repeat instruction as a result of the decoding by the instruction decoding unit 230, the program counter control unit 210 performs control under which the value of the program counter 211 is updated based on signals SGN, SGR outputted from the instruction decoding unit 230 so that a designated number N of repeat target instructions starting from a succeeding instruction, which is an instruction next to the repeat instruction, are repeatedly executed a designated number R of times. Further, when the instruction is the repeat instruction, the program counter control unit 210 notifies the repeat control unit 240, by a signal SAD, of address information indicating places where operands of the repeat target instructions that are to be executed are stored in an operand update buffer 241, and also notifies the repeat control unit 240, by a signal RCNT, of the number of times the execution has been repeated.

The instruction decoding unit 230 decodes the instruction read based on the value of the program counter 211 from an instruction area 220. When the instruction turns out to be an instruction 231 other than a repeat instruction as a result of the decoding, the instruction decoding unit 230 supplies an operation code (OPCODE) and operands of the instruction and the number of steps of the operands to the repeat control unit 240.

When the instruction turns out to be a repeat instruction 232 as a result of the decoding by the instruction decoding unit 230, the instruction decoding unit 230 notifies the program counter control unit 210, by a signal SGRPT, that the instruction is the repeat instruction, and also notifies the program counter control unit 210, by the signals SGN, SGR, the number N of repeat target instructions and the number R of repetition times which numbers are designated by the repeat instruction. The signals SGN, SGR have bit widths corresponding to the number N of instructions and the number R of repetition times that can be designated by the repeat instruction.

The repeat control unit 240 includes the operand update buffer 241, an adder 242, and a selector 243. The operand update buffer 241 includes a plurality of entries, in which the operands of the repeat target instructions that are to be repeatedly executed according to the repeat instruction are stored. The operand update buffer 241 outputs values stored in entries designated by the signal SAD outputted from the program counter control unit 210, as the operands of the repeat target instructions that are to be executed. The operand update buffer 241 stores updated operands of succeeding instructions in the entries designated by the signal SAD outputted from the program counter control unit 210. The updated operands are values that the adder 242 calculates by adding the operands of the repeat target instructions to be executed and the numbers of steps of the operands of the repeat target instructions.

The selector 243 selects the operands supplied from the instruction decoding unit 230 or the operands supplied from the operand update buffer 241, based on the signal RCNT outputted from the program counter control unit 210. Specifically, when the repeat target instructions are currently repeatedly executed according to the repeat instruction and the signal RCNT indicates that the number of times the execution has been repeated is two or more, the selector 243 selects the updated operands supplied from the operand update buffer 241, and otherwise, the selector 243 selects the operands supplied from the instruction decoding unit 230. Then, the repeat control unit 240 outputs an instruction 244 including the combination of the operands selected by the selector 243 and the opcode supplied from the instruction decoding unit 230, to an instruction processing unit.

As described above, the instruction control unit includes the operand update buffer unit 241 to hold all the updated operands of the repeat target instructions that are to be repeatedly executed according to the repeat instruction. Further, the instruction control unit updates the operands of the repeat target instructions to the updated operands that the adder 242 calculates by adding the operands of the repeat target instructions and the designated number of steps, every time the repeat target instructions are executed. Then, when the repeat target instructions are executed again for the second or later time according to the repeat instruction, the instruction control unit replaces the operands of the repeat target instructions by the updated operands stored in the operand update buffer 241 to output the resultant instructions. This eliminates a need for an instruction for updating a data referrer in repetitive arithmetic processing using a repeat instruction, enabling the elimination of wasteful instruction cycles not contributing to the operation.

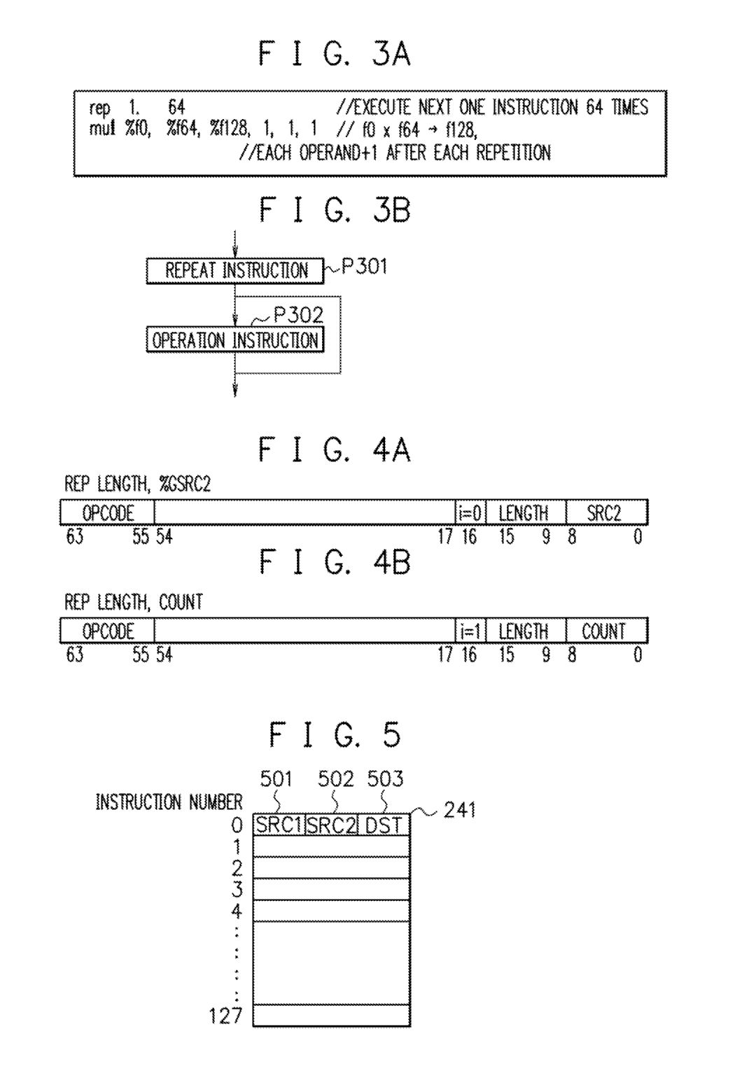

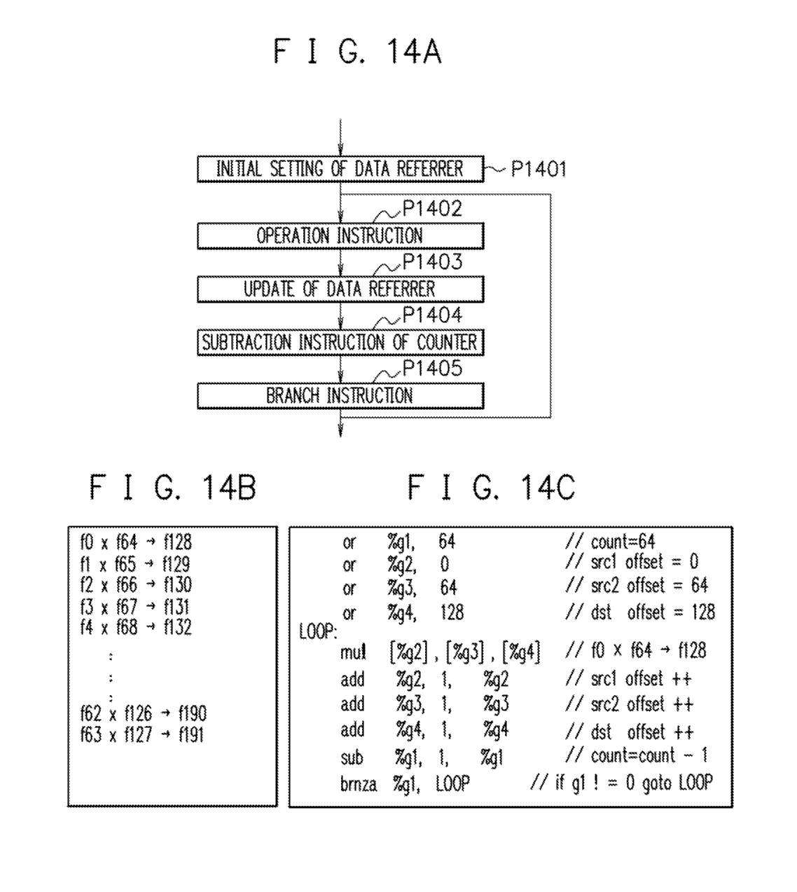

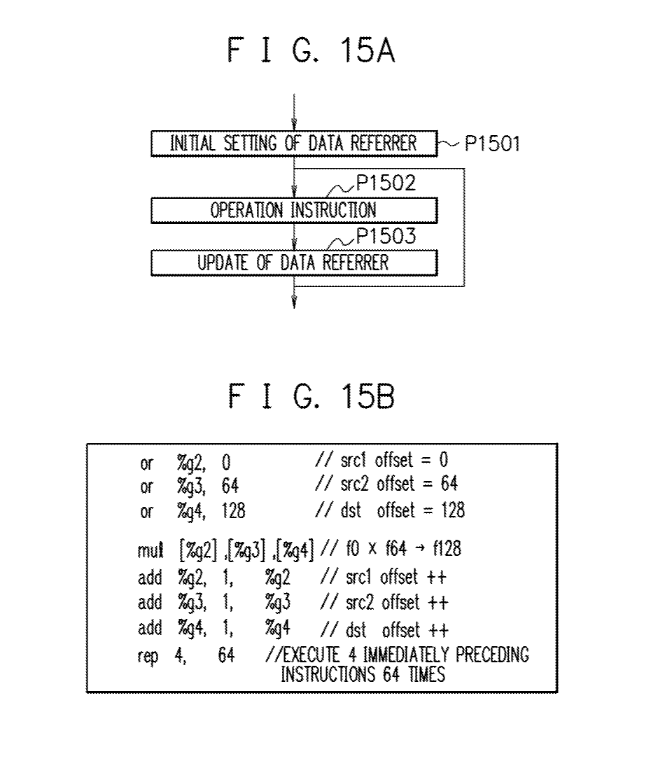

The processor in this embodiment is capable of executing, for example, the processing illustrated in FIG. 14B with a repeat instruction “rep” and an operation instruction “mul” as is seen in the coding example in FIG. 3A, and the repetitive arithmetic processing can be implemented with two phases, (1) P301: repeat instruction and (2) P302: operation instruction, as illustrated in FIG. 3B. At this time, an instruction repeatedly executed in the loop processing is only the operation instruction, making it possible to continuously give an operation instruction to an arithmetic unit every cycle. Thus, according to the processor in this embodiment, in the execution of the repetitive arithmetic processing, it is possible to eliminate instruction cycles not contributing to the operation, where processing relevant to the updating of a data referrer and branching is performed. This makes it possible to improve execution efficiency of the operation in the whole repetitive arithmetic processing.

Note that an instruction <rep 1, 64> in FIG. 3A indicates that one succeeding instruction is be repeatedly executed 64 times. An instruction <mul % f0, % f64, % f128, 1, 1, 1> is an operation instruction in which operands are % f0, % f64, and % f128 and the number of steps of each of the operands is 1, and indicates that the result of multiplication of values stored in floating-point registers % f0 and % f64 is stored in a floating-point register % f128, and the same operation is performed while operands used are incremented by +1 each time from the operands % f0, % f64, and % f128.

FIG. 4A and FIG. 4B are charts illustrating implementation examples of the repeat instruction “rep”. FIG. 4A illustrates an example where the number of repetition times according to the repeat instruction “rep” is obtained from a general register GSRC2, and instruction data includes opcode (operation code) of the repeat instruction “rep”, length (the number of instructions to be repeated), and src2 (register address). The repeat instruction rep illustrated in FIG. 4A instructs that repeat target instructions in number corresponding to the number of instructions designated by length (number of instructions) out of succeeding instructions be repeated the number of times corresponding to the value obtained from the general register GSRC2.

FIG. 4B illustrates an example where the number of repetition times according to the repeat instruction “rep” is designated in the instruction, and instruction data includes opcode (operation code) of the repeat instruction “rep”, length (the number of instructions to be repeated), and count (the number of repetition times). The repeat instruction “rep” illustrated in FIG. 4B instructs that repeat target instructions in number corresponding to the number of instructions designated by length (the number of instructions) out of succeeding instructions be repeated the number of times designated by count (the number of repetition times).

It is noted the above description is not restrictive, and the number of instructions to be repeated may be obtained from a general register, for instance. When a value of at least one of the number of instructions to be repeated and the number of repetition times in the repeat instruction “rep” is 0, the repeat instruction “rep” results in Nop (no operation) processing, and the processing is continued from the next instruction.

FIG. 5 is an explanatory chart of the operand update buffer 241 in the first embodiment. Where the processor supports operation instructions each with three operands at the maximum, namely, two sources (src1, src2) and one destination (dst), each entry of the operand update buffer 241 includes a field 501 storing the source src1, a field 502 storing the source src2, and a field 503 storing the destination dst as illustrated in FIG. 5.

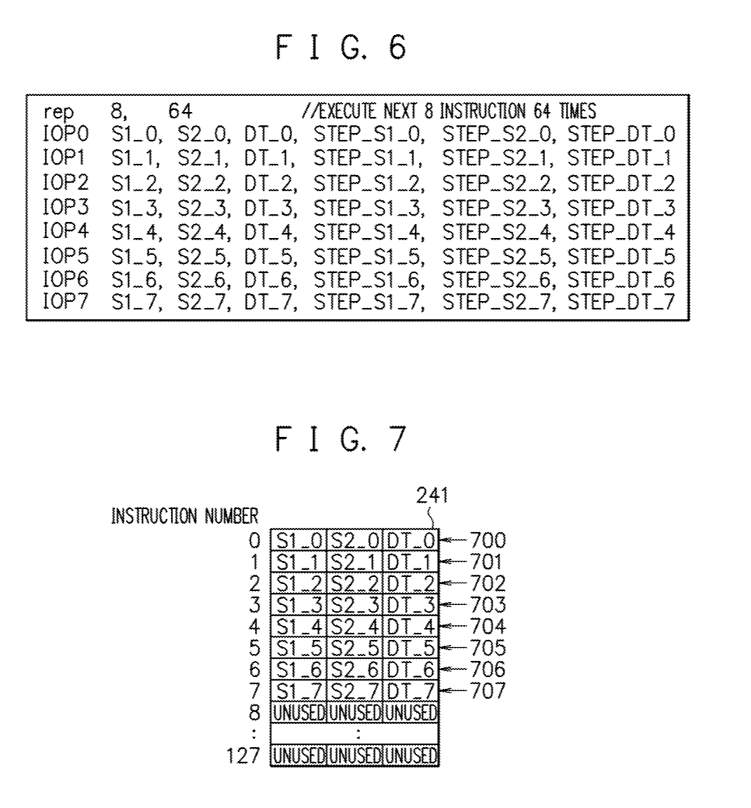

The entries of the operand update buffer 241 are allocated to respective repeat target instructions that are to be repeated according to the repeat instruction. For example, when eight instructions, instructions “IOP0” to “IOP7”, are repeatedly executed according to the repeat instruction “rep” as illustrated in FIG. 6, operands of the instructions “IOP0” to “IOP7” to be repeatedly executed are stored in the operand update buffer 241 as illustrated in FIG. 7. That is, the operands of the instruction “IOP0” are stored in an entry 700, and the operands of the instruction “IOP1” are stored in an entry 701. Similarly, the operands of the other instructions “IOP2” to “IOP7” are stored in entries 702 to 707 respectively according to the execution order of the repeat target instructions that are to be repeated.

In this example, the operand update buffer 241 includes 128 entries, but this is only one example, and it may include an appropriate number of entries according to, for example, the specification of the processor. Where the operand update buffer 241 includes 128 entries, the bit width of the signal SAD from the program counter control unit 210 is at least seven bits. That is, the signal SAD only needs to include a bit width large enough to uniquely designate an entry that the operand update buffer 241 includes.

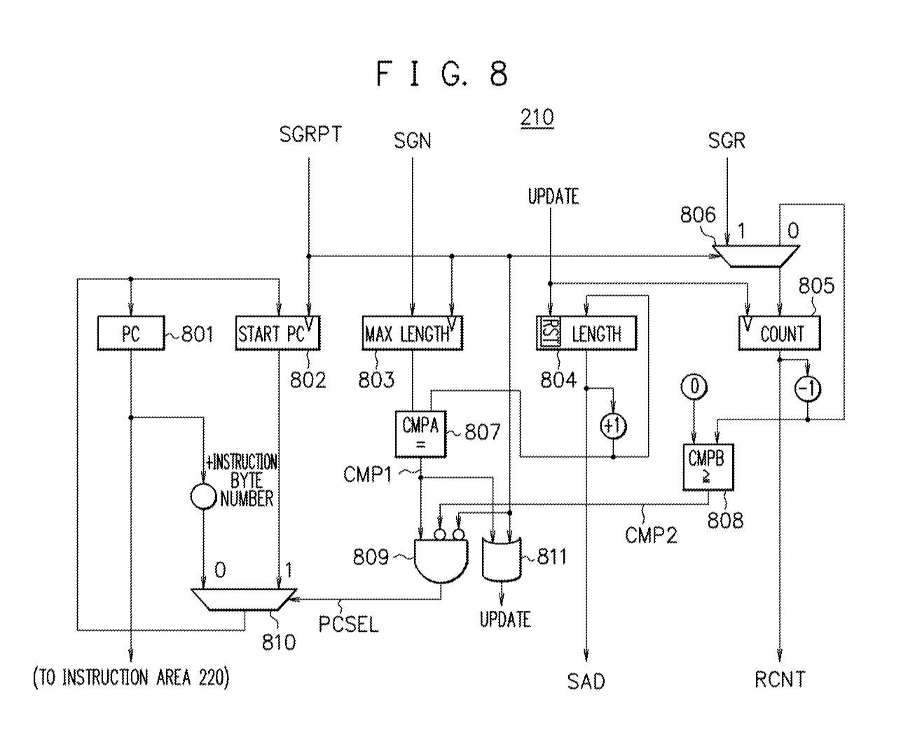

Next, the program counter control unit 210 in the first embodiment will be described. FIG. 8 is a diagram illustrating a configuration example of the program counter control unit 210. The program counter control unit 210 includes a PC register 801, a start PC register 802, a designated length register 803, an execution-completed length register 804, a repeat count register 805, selectors 806, 810, comparator circuits 807, 808, a logical product circuit (AND circuit) 809, and a logical sum circuit (OR circuit) 811.

The PC register 801 holds a program counter value. The start PC register 802 holds a program counter value of a head instruction (an instruction next to the repeat instruction) out of the repeat target instructions that are to be repeated according to the repeat instruction. The designated length register 803 holds the number of instructions to be repeated designated by the repeat instruction. The number N of the instructions to be repeated according to the repeat instruction is notified by the signal SGN from the instruction decoding unit 230.

While the repeat target instructions are repeatedly executed according to the repeat instruction, the execution-completed length register 804 holds which one of the repeat target instructions, in terms of the execution order, is currently executed. Note that, out of the repeat target instructions, the instruction that is executed first is the 0th instruction, and instructions thereafter are the 1st instruction, the 2nd instruction, . . . . While the repeat target instructions are repeatedly executed according to the repeat instruction, the repeat count register 805 holds the number of times the repetition has been performed. Note that the repeat count register 805 holds a value equal to the number of repetition times designated by the repeat instruction from which the number of times the repetition has been actually performed is subtracted. The values of the execution-completed length register 804 and the repeat count register 805 are supplied to the repeat control unit 240 as the signals SAD, RCNT respectively.

The selector 806 outputs one of the number R of repetition times which is notified by the signal SGR from the instruction decoding unit 230 and a value equal to the value of the repeat count register 805 from which one is subtracted, according to the signal SGRPT sent from the instruction decoding unit 230. The selector 810 outputs one of the value of the start PC register 802 and a value equal to the value of the PC register 801 to which the instruction byte number is added, according to an output signal pcse1 of the AND circuit 809.

The comparator circuit 807 compares the value of the designated length register 803 and a value equal to the value of the execution-completed length register 804 to which one is added. The comparator circuit 807 sets its output signal CMP1 to “1” when the both are equal, while setting the output signal CMP1 to “0” when the both are not equal. The comparator circuit 808 performs a comparison operation regarding the value equal to the value of the repeat count register 805 from which one is subtracted, to set its output signal CMP2 to “1” when the value equal to the value of the repeat count register 805 from which one is subtracted is 0, while setting the output signal CMP2 to “0” when this value is larger than 0.

The AND circuit 809 receives the output signal CMP1 of the comparator circuit 807, the output signal CMP2 of the comparator circuit 808, and the signal SGRPT outputted from the instruction decoding unit 230 and outputs the operation result. The AND circuit 809 sets its output signal PCSEL to “1” when the output signal CMP1 is “1” as well as the output signal CMP2 and the signal SGRPT are “0”, while, otherwise, setting the output signal PCSEL to “0”. That is, the AND circuit 809 sets the output signal PCSEL to “1” when all the following conditions are satisfied, that is, the value of the designated length register 803 equals to the value equal to the value of the execution-completed length register 804 to which one is added, the value equal to the value of the repeat count register 805 from which one is subtracted is not 0, and the instruction decoded by the instruction decoding unit 230 is not the repeat instruction.

The OR circuit 811 receives the signal SGRPT from the instruction decoding unit 230 and the output signal CMP1 of the comparator circuit 807, and outputs the operation result. The OR circuit 811 sets its output signal UPDATE to “1” when one of the signal SGRPT and the output signal CMP1 is “1”, while setting the output signal UPDATE to “0” when the signal SGRPT and the output signal CMP1 are both “0”. That is, the OR circuit 811 sets the output signal UPDATE to “1” when the instruction decoded by the instruction decoding unit 230 is the repeat instruction, or when the value of the designated length register 803 equals to the value equal to the value of the execution-completed length register 804 to which one is added.

When the repeat instruction is decoded by the instruction decoding unit 230, the signal SGRPT changes from “0” to “1” to indicate that the instruction is the repeat instruction. In accordance with the change of the signal SGRPT from “0” to “1”, the program counter control unit 210 holds, in the start PC register 802, the program counter value of the head instruction (instruction next to the repeat instruction) among the repeat target instructions that are be repeatedly executed according to the repeat instruction, and holds the number N of the instructions that are to be repeatedly executed according to the repeat instruction, in the designated length register 803. Further, in accordance with the change of the signal SGRPT to “1”, the output signal UPDATE of the OR circuit 811 becomes “1”, the number R of repetition times according to the repeat instruction is held in the repeat count register 805, and the value of the execution-completed length register 804 is reset to “0”.

When the signal SGRPT changes to “0” in the next cycle, the output signal UPDATE of the OR circuit 811 also changes to “0”. Then, the processing is performed while the instruction byte number is added to the value of the PC register 801 every cycle to sequentially update the program counter value. At this time, the value of the execution-completed length register 804 is increased by one every cycle, and when the resultant value reaches the value of the designated length register 803, the output signal CMP1 of the comparator circuit 807 changes to “1”.

If the number of repetition times according to the repeat instruction has not been reached when the output signal CMP1 of the comparator circuit 807 changes to “1”, the output signal PCSEL of the AND circuit 809 changes to “1”, and accordingly, the value of the PC register 801 is updated to the value of the start PC register 802. Further, in accordance with the change of the output signal CMP1 of the comparator circuit 807 to “1”, the output signal UPDATE of the OR circuit 811 changes to “1”, and accordingly, the value of the repeat count register 805 is updated to the value equal to the current value from which one is subtracted, and the value of the execution-completed length register 804 is reset to “0”.

When the output signal CMP1 of the comparator circuit 807 changes to “0” in the next cycle, the output signal UPDATE of the OR circuit 811 changes to “0”. Then, the processing is performed while sequentially updating the program counter value by adding the instruction byte number to the value of the PC register 801 every cycle, and every time the value equal to the value of the execution-completed length register 804 to which one is added reaches the value of the designated length register 803, the update of the value of the PC register 801 to the value of the start PC register 802, the subtraction of one from the repeat count register 805, and the resetting of the value of the execution-completed length register 801 to 0 are performed.

During the repetition of the above-described operation, when the output signal CMP1 of the comparator circuit 807 becomes “1” and at the same time the number of repetition times according to the repeat instruction is reached and the output signal CMP2 of the comparator circuit 808 is “0”, the output signal PCSEL of the AND circuit 809 remains “0”. Accordingly, the value of the PC register 801 is not updated to the value of the start PC register 802, and a processing target shifts to the next sequence of instructions. Note that the value of the PC register 801 is normally updated so as to increase by the instruction byte number every cycle, and the processing of the instruction is executed according to the value of the PC register 801.

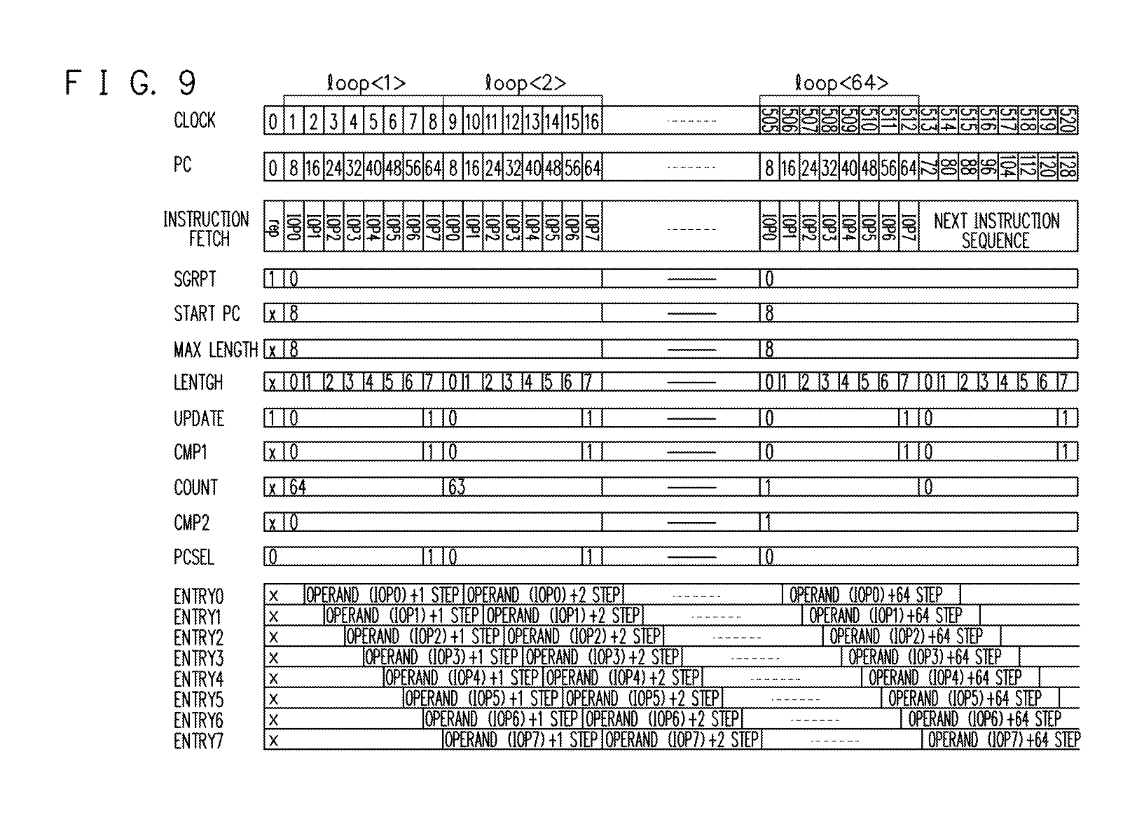

FIG. 9 illustrates a time chart when, in the processor in the first embodiment, the processing of the repeat instruction illustrated in FIG. 6 is performed, that is, when the execution of the eight operation instructions “IOP0” to “IOP7” which are repeat target instructions succeeding the repeat instruction, is repeated 64 times. In the 0th cycle in a clock, the repeat instruction “rep” is decoded, and in the 1st cycle to the 8th cycle, the instructions “IOP0” to “IOP7” are executed in sequence as the 1st-time loop processing loop<1>. Further, in accordance with the execution of the 1st-time loop processing loop<1> in the 1st cycle to the 8th cycle, the values equal to the initial operands of the instructions “IOP0” to “IOP7” to which (the number of steps×1) is added (updated operands) are stored in the entry 0 to the entry 7 of the operand update buffer 241.

After the execution of the 1st-time loop processing loop<1> in the 1st cycle to the 8th cycle, one is subtracted from the value of the repeat count register (COUNT), so that the value changes to 63, and the value of the PC register (PC) is updated to the value of the start PC register (START PC). Then, in the 9th cycle to the 16th cycle, the instructions “IOP0” to “IOP7” are sequentially executed as the 2nd-time loop processing loop<2>. Operands for use in the execution of the processing this time are the values stored in the entry 0 to the entry 7 of the operand update buffer 241 (updated operands). Further, in accordance with the execution of the 2nd-time loop processing loop<2> in the 9th cycle to the 16th cycle, values equal to the initial operands of the instructions “IOP0” to “IOP7” to which (the number of steps×2) is added are stored in the entry 0 to the entry 7 of the operand update buffer 241.

Thereafter, the processing is similarly performed, and after the 63rd-time loop processing is executed, one is subtracted from the value of the repeat count register (COUNT), so that the value changes to 1, and the value of the PC register (PC) is updated to the value of the start PC register (START PC). Then, in the 505th cycle to the 512th cycle, the instructions “IOP0” to “IOP7” are sequentially executed as the 64th-time loop processing loop<64>. Operands of the instructions “IOP0” to “IOP7” for use in the execution of the processing this time are values stored in the entry 0 to the entry 7 of the operand update buffer 241, that is, the values equal to the initial operands of the instructions “IOP0” to “IOP7” to which (the number of steps×63) is added. Then, after the 64th-time loop processing loop <64> in the 505th cycle to the 512th cycle is finished, a processing target shifts to the next sequence of instructions.

### Second Embodiment

Next, a second embodiment will be described. The second embodiment described below enables multiple loop processing in response to repeat instructions. In the multiple loop processing, during loop processing in response to a repeat instruction, loop processing in response to another repeat instruction is inserted. Hereinafter, differences of the second embodiment from the above-described first embodiment will be only described.

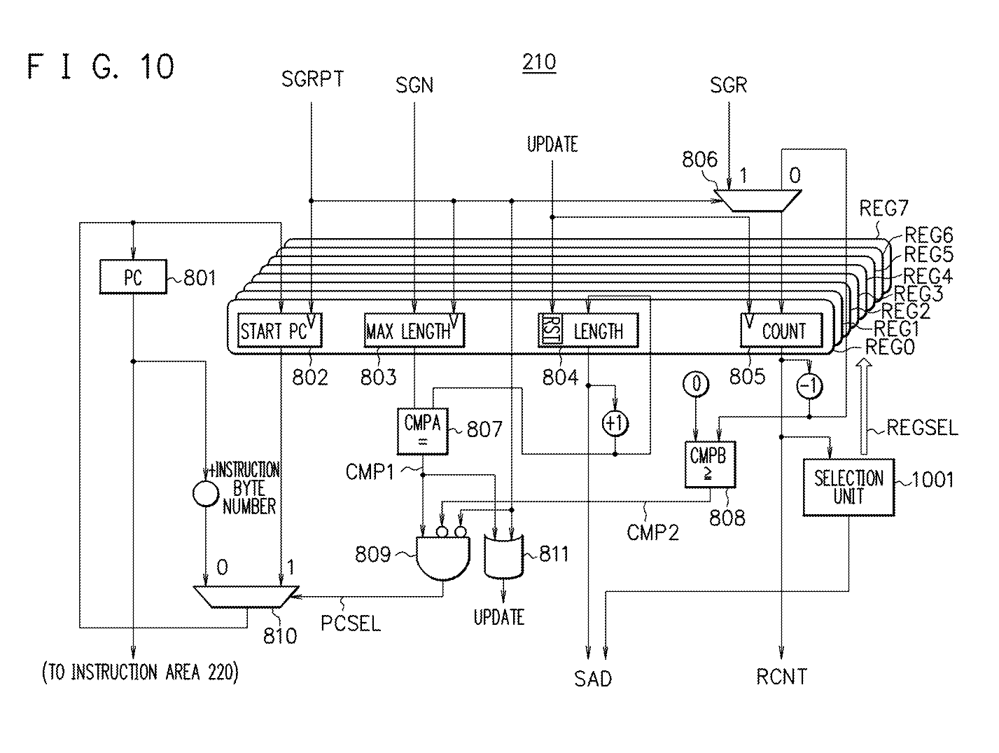

FIG. 10 is a diagram illustrating a configuration example of a program counter control unit 210 in the second embodiment. In FIG. 10, components having the same functions as the components illustrated in FIG. 8 are denoted by the same reference signs, and redundant description thereof will be omitted. The program counter control unit 210 includes a PC register 801, a start PC register 802, a designated length register 803, an execution-completed length register 804, a repeat count register 805, selectors 806, 810, comparator circuits 807, 808, an AND circuit 809, an OR circuit 811, and a selection unit 1001.

The program counter control unit 210 in the second embodiment includes a plurality of control register sets each including the start PC register 802, the designated length register 803, the execution-completed length register 804, and the repeat count register 805. In the example illustrated in FIG. 10, the program counter control unit 210 includes eight control register sets REG0 to REG7. Note that the example illustrated in FIG. 10 is only one example, and the number of the control register sets included in the program counter control unit 210 may be the number according to the allowable number of the multiple loop processing executed according to the repeat instructions.

The PC register 801, the selectors 806, 810, the comparator circuits 807, 808, the AND circuit 809, and the OR circuit 811 do not have to be provided for each of the control register sets REG0 to REG7, and the same control as that in the first embodiment may be performed for a control register set selected according to an output signal REGSEL of the selection unit 1001 out of the control register sets REG0 to REG7. Further, where the eight control register sets REG0 to REG7 are provided, the number of entries of an operand update buffer 241 of a repeat control unit 240 also increases by eight times, and accordingly the bit width of a signal SAD also increases.

It is assumed here in this embodiment that the control register sets REG0, REG1, REG2, REG3, REG4, REG5, REG6, and REG7 are used in the order mentioned. For example, the control register set REG0 is used for the first repeat instruction, the control register set REG1 is used for the second repeat instruction in the first repeat instruction, and the control register set REG2 is used for the third repeat instruction in the second repeat instruction.

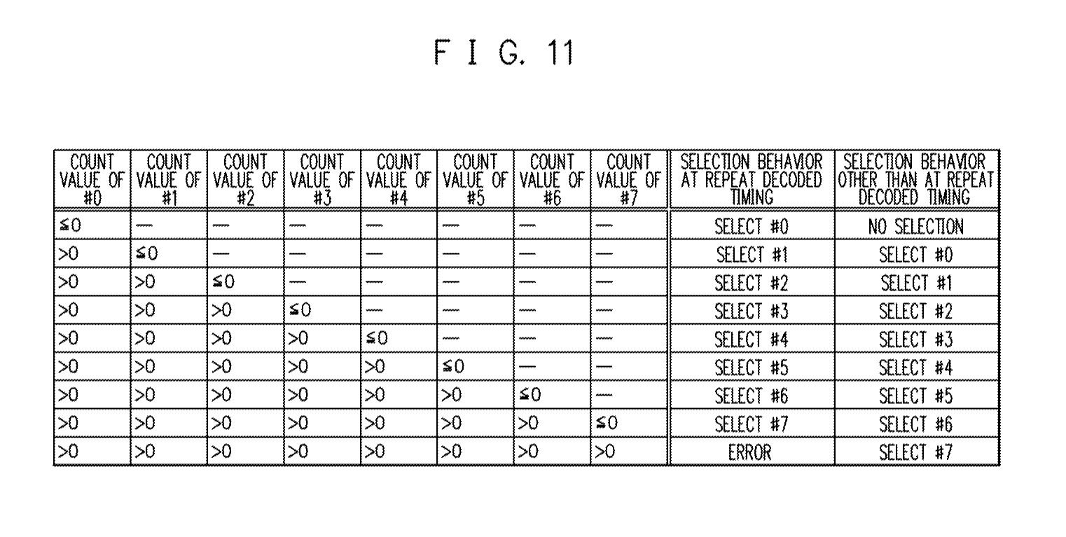

The selection unit 1001 evaluates values of the repeat count registers 805 included in the control register sets REG0 to REG7, and selects a control register set to be controlled out of the control register sets REG0 to REG7 according to the control register set selection logic illustrated in FIG. 11. Further, the selection unit 1001 outputs the number assigned to the selected control register set to be controlled to the repeat control unit 240 as a signal SAD in which a value of the execution-completed length register 804 is combined.

When, for example, a signal SGRPT from an instruction decoding unit 230 is “1”, that is, when a decoded instruction is a repeat instruction, the selection unit 1001 selects, by means of the output signal REGSEL, one control register set out of the control register sets REG0 to REG7 whose repeat count registers 805 have a value of “0” (which are not used), in order of the control register sets REG0, REG1, REG2, . . . , REG7. On the other hand, when the signal SGRPT from the instruction decoding unit 230 is “0”, the selection unit 1001 selects, by means of the output signal REGSEL, one control register set out of the control register sets REG0 to REG7 whose repeat count registers 805 have values larger than “0”, in order of the control register sets REG7, REG6, REG5, . . . REG0. Therefore, in the case where the signal SGRPT from the instruction decoding unit 230 is “0”, when the value of the repeat count register 805 becomes “0” while, for example, the control register set REG3 is selected, the control register set REG2 is selected and controlled next.

Thus, in the processor in the second embodiment, the plural control register sets are provided, and the control register set to be controlled is changed among them. This control makes it possible to execute the multiple loop processing according to the repeat instructions. Further, the behavior according to each of the repeat instructions is the same as that in the first embodiment. Therefore, in the execution of the repetitive arithmetic processing, it is possible to eliminate instruction cycles not contributing to the operation, where processing relevant to the updating of a data referrer and branching is performed. This makes it possible to improve execution efficiency of the operation in the whole repetitive arithmetic processing.

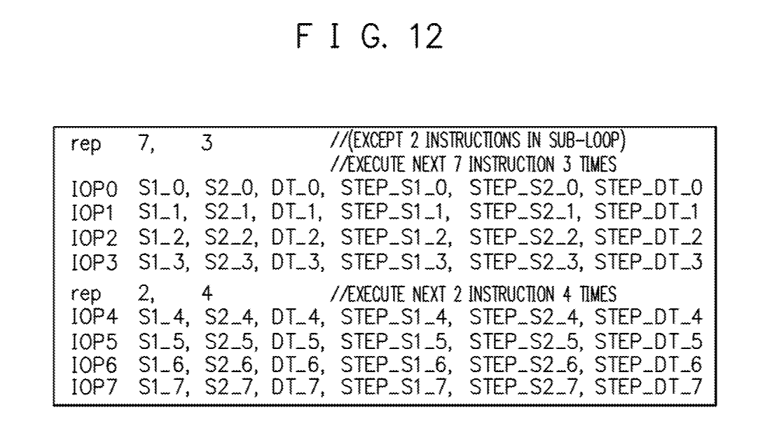

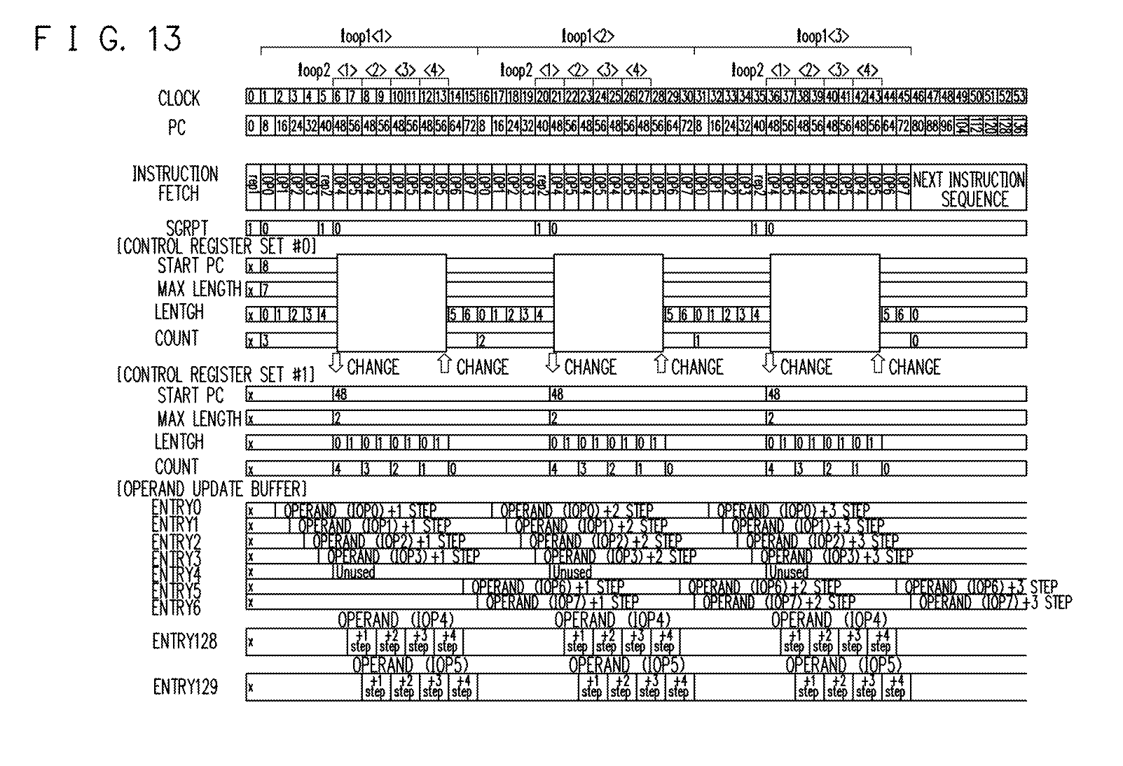

FIG. 13 illustrates a time chart when the processor in the second embodiment processes repeat instructions illustrated in FIG. 12. In the processing illustrated in FIG. 12, while instructions “IOP0” to “IOP3”, a repeat instruction <rep 2, 4>, and instructions “IOP6” to “IOP7”, which are repeat target instructions, are repeatedly executed three times according to a repeat instruction <rep 7, 3>, an instruction “IOP4” and an instruction “IOP5”, which are repeat target instructions, are repeatedly executed between the instruction “IOP3” and the instruction “IOP6” four times according to the repeat instruction <rep 2, 4>. That is, a series of processing in which the instructions “IOP0” to “IOP3” are executed, the instruction “IOP4” and the instruction “IOP5” are repeatedly executed four times, and the instruction “IOP6” and the instruction “IOP7” are executed is repeatedly executed three times.

The repeat instruction <rep 7, 3> is decoded in the 0th cycle in a clock, and the execution of the 1st-time first loop processing loop1<1> relevant to the repeat instruction <rep 7, 3> is started in the 1st cycle, using the control register set REG0. Further, in accordance with the execution of the 1st-time first loop processing loop1<1> started in the 1st cycle, values equal to initial operands of the instructions “IOP0” to “IOP3”, “IOP6” to “IOP7” to which (the number of steps×1) is added (updated operands) are stored in an entry 0 to an entry 6 of the operand update buffer 241.

In the 1st-time first loop processing loop1<1>, the repeat instruction <rep 2, 4> is decoded in the 5th cycle following the execution of the instruction “IOP3”, the control register set to be controlled is changed from REG0 to REG1, and the execution of the 1st-time second loop processing loop2<1> relevant to the repeat instruction <rep 2, 4> is started in the 6th cycle. Further, in accordance with the execution of the 1st-time second loop processing loop2<1> started in the 6th cycle, values equal to the initial operands of the instructions “IOP4”, “IOP5” to which (the number of steps×1) is added (updated operands) are stored in entries 128, 129 of the operand update buffer 241.

Subsequently, the execution of the 2nd-time second loop processing loop2<2> relevant to the repeat instruction <rep 2, 4> is started in the 8th cycle, and values equal to the initial operands of the instructions “IOP4”, “IOP5” to which (the number of steps×2) is added are stored in the entries 128, 129 of the operand update buffer 241. Similarly, the execution of the 3rd-time second loop processing loop2<3> relevant to the repeat instruction <rep 2, 4> is started in the 10th cycle, and the execution of the 4th-time second loop processing loop2<4> relevant to the repeat instruction <rep 2, 4> is started in the 12th cycle.

In the 14th cycle which is subsequent to the completion of the 4th-time second loop processing loop2<4> relevant to the repeat instruction <rep 2, 4> started in the 12th cycle, the control register set to be controlled is changed from REG1 to REG0, and the instruction “IOP6” and the instruction “IOP7” involved in the 1st-time first loop processing loop1<1> are executed.

After the execution of the 1st-time first loop processing loop1<1>, one is subtracted from the value of the repeat count register (COUNT) of the control register set REG0 involved in the first loop processing, so that this value becomes 2. Thereafter, in the 16th cycle, the same processing is started, and the 2nd-time first loop processing loop1<2> and the four times of the second loop processing in each first loop processing are executed. At this time, updated operands for use in the next execution of the repeat target instructions are stored in the entry 0 to the entry 7 and the entries 128, 129 of the operand update buffer 241. Then, when the processing of the instruction “IOP7” according to the repeat instruction is finished in the 45th cycle, a processing target shifts to the next sequence of instructions.

It should be noted that the above-described embodiments all illustrate only examples of embodiments in carrying out the present invention, and are not to be construed as limitations to the technical scope of the present invention. That is, the present invention can be embodied in a variety of forms without departing from its technical idea or its main features.

In an embodiment, when operation instructions are repeatedly executed, it is possible to eliminate instruction cycles not contributing to the operation, where processing relevant to the updating of a data referrer and branching is performed. This makes it possible to improve execution efficiency of the operation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a storage unit that stores a plurality of instructions;
a counting unit that specifies an instruction to be decoded by a count value;
a decoding unit that decodes an instruction read based on the count value from the storage unit; and
a control unit that, when the instruction decoded by the decoding unit is a repeat instruction, updates the count value of the counting unit so as to cause repeat target instructions in number corresponding to a designated number of instructions, out of instructions succeeding the repeat instruction, to be repeatedly executed a designated number of repetition times, and generates updated operands being operation objects of the repeat target instructions that are to be executed for the second or later time, and when the repeat target instructions are to be executed for the second or later time, updates operands of the repeat target instructions for use in the second or later time execution, to the generated updated operands and outputs the updated operands.

2. The processor according to claim 1,
wherein the control unit includes a holding unit that includes a plurality of entries and holds the operands of the repeat target instructions in respective entries allocated to the respective repeat target instructions out of the plural entries, and in which the operands stored in the plural entries are updated to the updated operands every time the repeat target instructions are executed; and
wherein, when the repeat target instructions are to be executed, the control unit updates operands of the repeat target instructions for use in the second or later time execution, to the generated updated operands stored in the holding unit to output the updated operands.

3. The processor according to claim 2, wherein the operands stored in the plural entries are updated based on the number of steps designated in the repeat target instructions.

4. The processor according to claim 1,
wherein the control unit includes a register which holds the count value of the counting unit, corresponding to an instruction succeeding the repeat instruction, and
wherein, every time the repeat target instructions in number corresponding to the designated number of instructions succeeding the repeat instruction are executed, the control unit updates the count value of a repeat target instruction to be executed, to the count value held in the register.

5. A control method of a processor including a storage unit that stores a plurality of instructions, the control method comprising:
specifying, by a counting unit of the processor, an instruction to be decoded, by a count value;
decoding, by a decoding unit of the processor, an instruction read based on the count value from the storage unit; and
by a control unit of the processor, when the instruction decoded by the decoding unit is a repeat instruction, updating the count value of the counting unit so as to cause repeat target instructions in number corresponding to a designated number, out of instructions succeeding the repeat instruction, to be repeatedly executed a designated number of repetition times, and generating updated operands being operation objects of the repeat target instructions that are to be executed for the second or later time, and when the repeat target instructions are to be executed for the second or later time, updating operands of the repeat target instructions for use in the second or later time execution, to the generated updated operands and outputting the updated operands.
